(19) United States
(12) Patent Application Publication
(10) Pub. No.: US 2002/0148122 A1
(43) Pub. Date: Oct. 17, 2002

(54) Can opener

(75) Inventors: Albert L. Sanchez, Naugatuck, CT (US); C. Sven Johnson, Beacon Falls, CT (US); David Robert Arnott, Hamden, CT (US); Anthony M. DeMore, Greenwich, CT (US); Craig A. DuBois, Trumbull, CT (US); Keith C. Bernard, Trumbull, CT (US); Stuart Naft, Fairfield, CT (US)

Correspondence Address: BARRY E DEUTSCH, 6 ARMSTRONG RD, SHELTON, CT, 06484, US

(73) Assignee: HP INTELLECTUAL CORP.

(21) Appl. No.: 09/836,790

(22) Filed: Apr. 17, 2001

(51) Int. Cl. B67B 7/46; B67B 7/70

(52) U.S. Cl. 30/421; 30/426; 30/423

(57) ABSTRACT

A hand held battery operated can opener comprising a housing; a drive located in the housing and having a can contacting drive wheel; a rechargeable battery connected to the drive; and a movable section movably connected to the housing. The movable section comprises a cutting blade. The housing is sized and shaped to be grasped by a single hand of a user in a grasping position. The grasping position comprises a back of the housing being matingly received in a palm of the hand and fingers of the hand being located at left and bottom sides of the housing and, while the user is grasping the housing in the grasping position, at least one finger of the hand can articulate to move the movable section.

### BACKGROUND OF THE INVENTION

1. Field of the Invention

The present invention relates to a household appliance and, more particularly, to a can opener.

2. Prior Art

Many different types of can openers are known in the prior art. U.S. Pat. No. 5,664,333 discloses a hand held and base operated can opener combination. Can openers are also known in the art which are attached to an underside of a kitchen cabinet. There is a desire to provide a can opener which can be attached to an underside of a kitchen cabinet and which can also be removed from the kitchen cabinet for hand-held use. There is also a desire to provide a can opener mount, for removably receiving a removable can opener, which can be attached to an underside of a kitchen cabinet or, alternatively, be placed on top of a flat countertop surface. There is also a desire to provide a battery operated can opener which has an ergonomic shape to fit within a palm of a user's hand without the need for the can opener to have a separate handle. There is also a desire to provide a battery operated can opener which can operate while attached to a can opener mount which is mounted to an underside of a cabinet.

### SUMMARY OF THE INVENTION

In accordance with one embodiment of the present convention, a hand held battery operated can opener is provided comprising a housing; a drive located in the housing and having a can contacting drive wheel; a rechargeable battery connected to the drive; and a movable section movably connected to the housing. The movable section comprises a cutting blade. The housing is sized and shaped to be grasped by a single hand of a user in a grasping position. The grasping position comprises a back of the housing being generally matingly received in a palm of the hand and fingers of the hand being located at left and bottom sides of the housing and, while the user is grasping the housing in the grasping position, at least one finger of the hand can articulate to move the movable section.

In accordance with another embodiment of the present invention, a hand held battery operated can opener is provided comprising a housing; a drive located in the housing and having a can contacting drive wheel; a rechargeable battery connected to the drive; and a movable section movably connected to the housing. The movable section comprises a cutting blade. The housing has a main section with a general rounded shape without a handle section extending from the main section. The main section is sized and shaped to be held in a palm of a single hand of a user along a majority of its length.

In accordance with another embodiment of the present invention, a can opener assembly is provided comprising a hand held can opener comprising a battery; and a can opener mounting receptacle comprising a housing having a receiving area for removably receiving the can opener, electrical contacts at the receiving area, and an AC/DC transformer connected to the contacts. The can opener is adapted to operate when it is out of the receiving area by use of the battery and, when the can opener is in the receiving area, the can opener is adapted to operate by use of the battery and can receive electricity from the contacts to recharge the battery. The housing is adapted to be mounted to an underside of a cabinet.

In accordance with another embodiment of the present invention, a can opener assembly is provided comprising a hand-held can opener comprising a battery; and a can opener mount having a housing. The housing has a front side with a can opener receiving area for removably mounting the can opener to the can opener mount, and a top side adapted to be attached to an underside of a cabinet.

In accordance with another embodiment of the present invention, a can opener assembly is provided comprising a hand held can opener; a can opener mount having a housing with a can opener receiving area; and a latching system for removably connecting the can opener to the mount in the receiving area. The latching system comprises the can opener having a first recess on a first side and a first projection on a second side. The housing has a second recess proximate the receiving area. A movable latch is connected to the housing for engaging the first recess when the can opener is positioned in the receiving area.

In accordance with another embodiment of the present invention, a household appliance is provided comprising a working unit comprising a rechargeable battery; and a combined battery recharger and working unit mount having a housing with a working unit receiving area, electrical contacts connected to the housing, and a transformer connected to the contacts. The receiving area is adapted to receive the working unit therein. The housing comprises a first side with holes and a second side with a perimeter section forming an end of the second side along a plane. The housing is adapted to be mounted to an underside of a cabinet with the first side facing the underside of the cabinet and, the housing is adapted to be alternatively placed on a flat countertop surface with the end at the second side being located on the countertop surface to stabilize the housing on the countertop surface.

In accordance with another embodiment of the present invention, a can opener is provided having a housing, a drive located in the housing, a movable cutting blade connected to the housing and, a lid retainer connected to the housing. The lid retainer includes an arm connected to the housing with a lid contacting extension extending downward from an end of the arm. A magnet and plunger assembly is movably connected to the end of the arm. A spring biases the magnet and plunger assembly in an upward direction. The magnet and plunger assembly is movable relative to the lid contacting extension such that a user can pull upward on the magnet and plunger assembly to separate a magnet of the magnet and plunger assembly from a cut lid magnetically attached to the magnet.

### BRIEF DESCRIPTION OF THE DRAWINGS

The foregoing aspects and other features of the present invention are explained in the following description, taken in connection with the accompanying drawings, wherein:

FIG. 1 is a perspective view of a can opener assembly incorporating features of the present invention shown attached to an underside of a cabinet;

FIG. 2 is a perspective view of the working unit recharger and mounting receptacle of the assembly shown in FIG. 1;

FIG. 3 is an elevational front view of the can opener of the assembly shown in FIG. 1;

FIG. 4 is a top plan view of the can opener shown in FIG. 3;

FIG. 5 is a bottom plan view of the can opener shown in FIG. 3;

FIG. 6 is an exploded perspective view of some of the components of the can opener shown in FIG. 3;

FIG. 7A is an exploded perspective view of the can opener and a user's hand;

FIG. 7B is a perspective view of the can opener shown in FIG. 3 being grasped by a hand of a user;

FIG. 8 is a schematic cross sectional view of the lid retainer of the can opener show in FIG. 3;

FIG. 9 is a schematic cross sectional view of the lid retainer shown in FIG. 8 attached to a cut lid; and

FIG. 10 is a perspective view of the can opener assembly shown in FIG. 1 located on a countertop surface.

### DETAILED DESCRIPTION OF THE PREFERRED EMBODIMENT

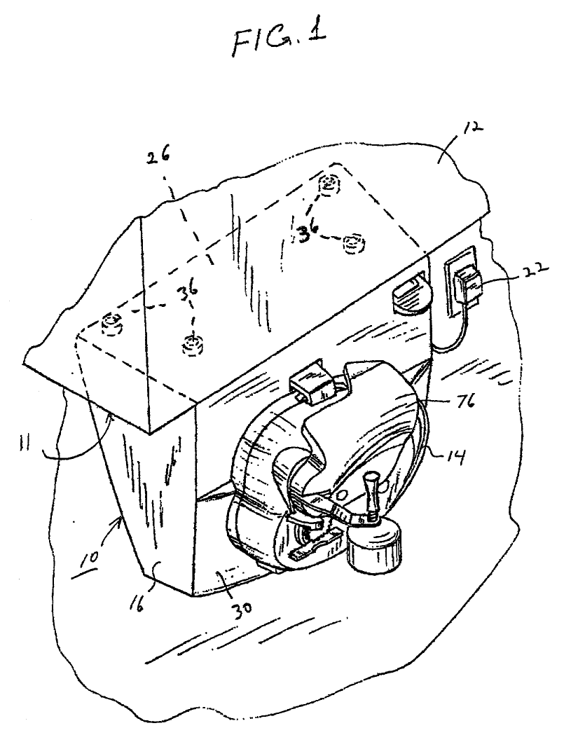

Referring to FIG. 1, there is shown a perspective view of a can opener assembly 10 incorporating features of the present invention shown attached to an underside of a cabinet 12. Although the present invention will be described with reference to the single embodiment shown in the drawings, it should be understood that the present invention can be embodied in many alternate forms of embodiments. In addition, any suitable size, shape or type of elements or materials could be used. Although the present invention will be described with reference to a can opener, features of the present invention could be embodied in any suitable type of household appliance. In addition, although the present invention will be described with reference to mounting the assembly to an underside of a kitchen cabinet or to a top of a countertop surface, the present invention could be adapted to be mounted to any suitable surface including a vertical surface or surfaces which are not horizontal. The assembly could be suspended in any suitable manner or could be adapted to be supported or rest on any suitable type of surface.

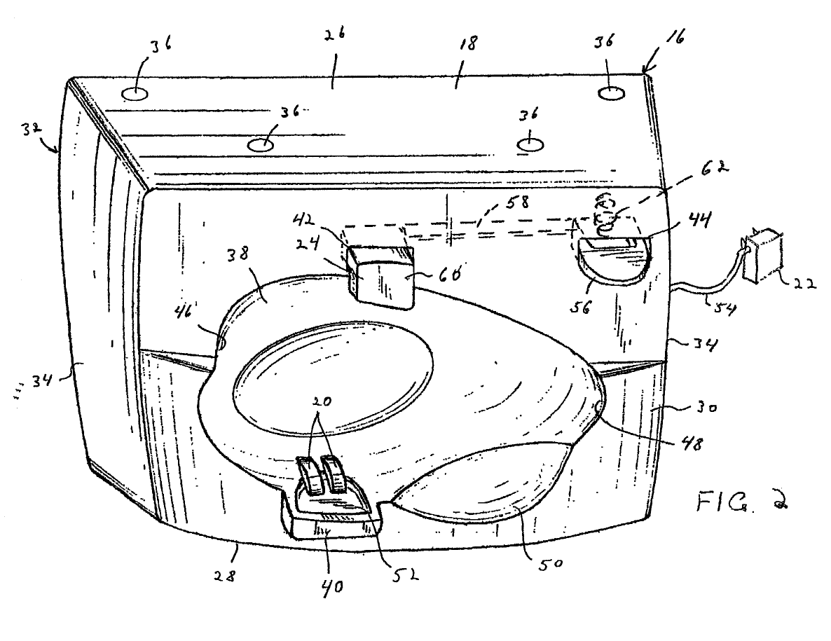

The can opener assembly 10 generally comprises a can opener 14 and a mount 16. Referring also to FIG. 2, the mount 16 generally comprises a housing 18, electrical contacts 20, an AC/DC transformer 22, and a latch 24. In an alternate embodiment the mount 16 could have additional or alternative components. In the embodiment shown, the housing 18 is preferably a one-piece molded plastic member. In this embodiment the housing 18 has a general box like shape. The housing 18 comprises a first top side 26, a second bottom side 28, a third front side 30, a rear side 32, and two laterals sides 34. The top side 26 has a longer depth than the bottom side 28. Thus, the two lateral sides 34 have a general wedge shape between the bottom side 28 and the top side 26. However, in alternate embodiments, any suitable shape could be provided.

The top side 26 comprises mounting holes 36. Fasteners (not shown) can be located in the holes 36 and attached to the underside 11 of the cabinet 12 to fixedly and stationarily attach the housing 18 to the underside of the cabinet. If desired, spacers can be positioned between the underside 11 of the cabinet and the top side 26 of the housing 18.

The rear side 32 of the housing forms a rear end of the housing which comprises a perimeter section of the four sides 26,28,34 and 34. The perimeter section forms the rear end of the housing as a substantially flat end along a plane. The front side 30 of the housing 18 generally comprises a main can opener receiving area 38, a projection 40, and two holes 42,44. In this embodiment, the front generally planar face of the front side 30 is substantially perpendicular to the top side 26. Therefore, if the underside 11 of the cabinet 12 is substantially horizontal, when the mount 16 is attached to the underside of 11 of the cabinet, the front generally planar face of the front side 30 can be substantially orientated in a vertical orientation.

The can opener receiving area 38 has a general concave shape. In the embodiment shown, the receiving area 38 has a general egg shaped profile. However, in alternate embodiments, the receiving area could have any suitable type of shape. In this embodiment, the general egg shaped profile comprises a left side 46 of the receiving area having a taller height than a right side 48 of the receiving area. A middle section of the receiving area 38 is larger than the left side 46 of the receiving area. In this embodiment, the length of the receiving area 38 and the height of the receiving area are both larger than the depth of the receiving area. The receiving area 38, in this embodiment, also comprises a finger recess 50 to allow a user's finger to extend under the can opener 14 a further distance than otherwise would be possible.

The projection 40, in this embodiment, is located at the bottom of the receiving area 38. However in alternate embodiments the projection 40 might not be provided, or could be provided at any suitable location. The projection 40 has a recess 52 in its top surface. The recess 52 extends into the receiving area 38. In this embodiment the contacts 20 are located at the bottom of the receiving area 38 proximate the recess 52. However, in alternate embodiments the contacts 20 could be located at any suitable position.

The contacts 20, in this embodiment, comprises spring contacts. However, any suitable type of electrical contacts or electrical connector could be provided. The contacts 20 are connected by an electrical wire 54 to the AC/DC transformer 22. The transformer 22 is adapted to be plugged into any suitable type of electrical outlet. Thus, the transformer 22 can supply DC voltage to the contacts 20. In an alternate embodiment, transformer 22 might not be provided.

The latch 24 generally comprises a user actuatable lever section 56, a rotatable rod section 58, a latch arm 60, and a spring 62. The lever section 56 and the latch arm 60 extend out of the holes 42,44 in substantially the same forward direction. The latch arm 60 comprises a section which extends downward in front of a portion of the main can opener receiving area 38. The lever section 56 is fixedly attached to the latch arm 60 by the rod section 58. The spring 62 biases the lever section 56 and the latch arm 60 in a downward position. However, a user can move the lever section 56 in an upward direction. This results in the rod section 58 being axially rotated. This, in turn, causes the latch arm 60 to be pivoted in an upward direction. When the user releases the lever section 56, the spring 62 biases the lever section 56 back to its down position. The latch arm 60 is, thus, also biased back down to its downward latching position. In an alternate embodiment, any suitable type of latching system could be provided.

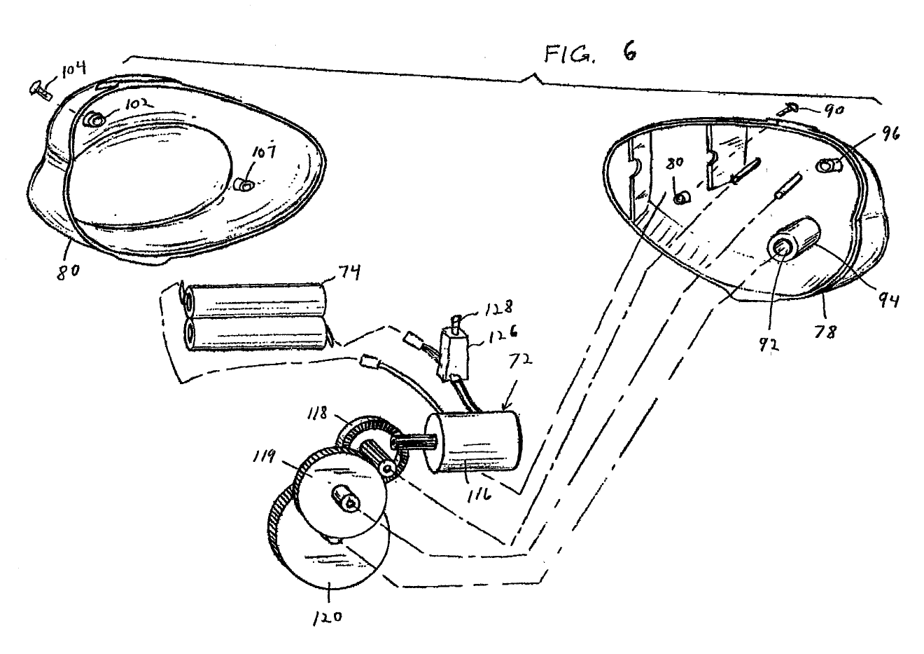

Referring also to FIGS. 3 through 6, the can opener 14 generally comprises a housing 70, a drive 72, a battery 74, and a movable section 76. However, in alternate embodiments, the can opener could comprise additional or alternative components. The housing 70 comprises two housing pieces 78,80. The two housing pieces 78,80 have general clamshell shapes such that, when they are connected to each other, they form an interior cavity. The drive 72 and the battery 74 are located in the interior cavity. The housing 70 is preferably provided as a general rounded shape. In the embodiment shown, the housing 70 comprises a general egg shape with a left end 82 which is larger than a right end 84, and a middle section between the two ends 82,84 which is larger than the two ends. However, the housing could have any suitable type of shape.

The front housing piece 78 has a front flat section 86. The front housing piece 78 also comprises a hole 88 for a first fastener 90, a drive shaft support boss 94 having a hole 92 and, and a second fastener mount 96. The rear housing piece 80 preferably comprises a first member 98 comprising a relatively hard plastic and a second member 100 comprising an over molded relatively soft polymer material. However, any suitable member(s) or materials(s) could be used. The rear housing piece 80 generally comprises a hole 102 for a second fastener 104. The rear housing piece also comprises holes 106 for electrical contacts 108. The electrical contacts 108 are electrically connected to the battery 74. The rear housing piece 80 also comprises a fastening boss 107 for the first fastener 90. The location of the holes 80,92,102 form a triangular pattern which allows the two housing pieces 78,80 to be fixedly attached to each other by the use of only two fasteners 90,104. However, in alternate embodiments, any suitable attachment system could be used.

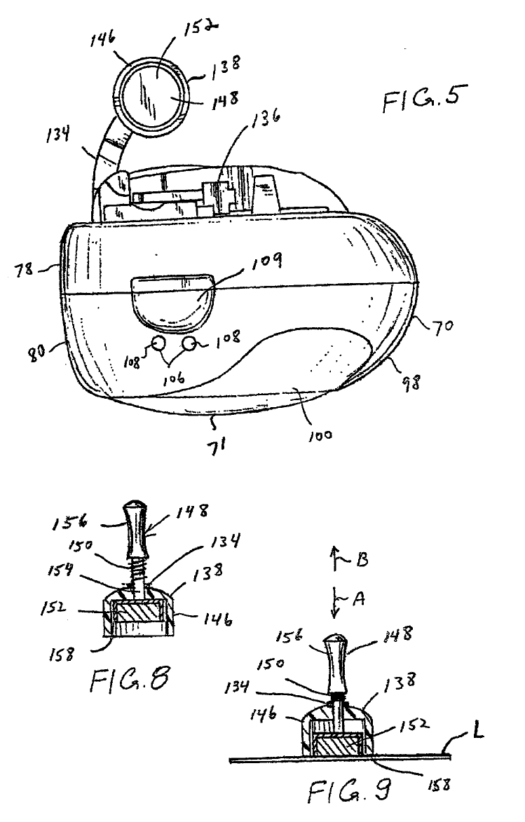

As seen best in FIGS. 3 and 5, the two housing pieces 78,80 have projections on their bottom sides which form a mounting projection 109 on the bottom side of the can opener. However, in alternate embodiments, the can opener might not have a mounting projection, such as when the can opener merely comprises mounting recesses. Alternatively, mounting projection(s) could be provided on any suitable side(s). The projection 109 is sized and shaped to be matingly received in the recess 52 of the mount 16.

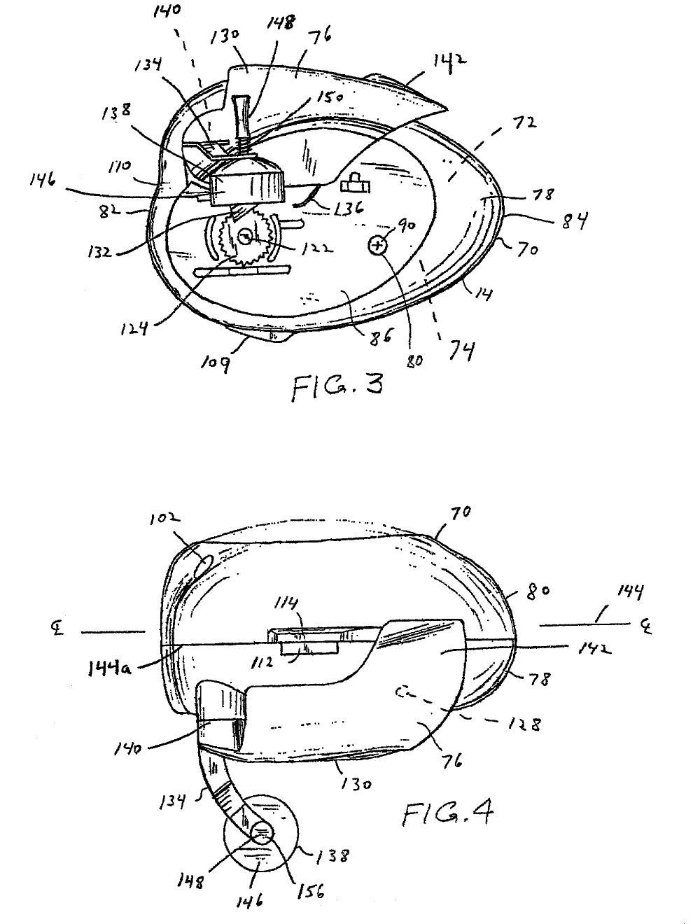

The two housing pieces 78,80 have an indentation in their left sides to form a finger receiving recess 110 in the left side 82 of the can opener. As seen in FIG. 4, the two housing pieces 78, 80 form a mounting recess 112 in the top side of the housing 70 and a rearward facing ramp and ledge 114 leading into the recess 112. However, in an alternate embodiment the can opener might not have a mounting recess, such as when the can opener merely comprises mounting projections. Alternatively, mounting recess(es) could be provided in any suitable side(s).

The drive 72 generally comprises a motor 116, gears 118,119,120, an output shaft 122 and a can contacting wheel 124. The first and third gears 118,120 have relatively large main gear sections which are substantially aligned with each other in a single plane. The first gear 118 is connected to an output shaft from the motor 116. The third gear 120 is connected to the drive shaft 122. The three gears 118,119,120 are operably connected in series such that the output from the motor 116 can rotate the drive shaft 122 which, in turn, can rotate the can contacting wheel 124. One of the features of the present invention is the positioning of the three gears 118,119,120. Because the relatively large main gear sections of the first and third gears 118,120 are aligned in the same plane, the thickness of the three gears is less than the thickness of a conventional can opener gear assembly. This reduced thickness allows the front-to-back dimension of the housing 70 to be reduced. This, in turn, allows for a more compact can opener for easier one hand grasping and operation by a user.

The motor 116 is electrically connected to the battery 74 by wires and a control switch 126. The battery 74 is preferably a rechargeable battery. However, in an alternate embodiment, the battery 74 might not be rechargeable. The control switch 126 comprises a moveable plunger 128. The plunger 128 extends through a hole through the top of the housing 70. The plunger 128 is adapted to be depressed by the movable section 76 when the movable section 76 is depressed towards the housing 70. Actuation of the switch 126 controls activation of the motor 116. In alternate embodiments any suitable type of drive could be provided. In addition, any suitable type of drive actuation system could also be provided.

The moveable section 76 generally comprises a main section 130, a cutting blade 132, an arm 134, a spring 136, and a lid retainer assembly 138. The main section 130 is pivotably mounted to the housing 70 at a pivot mount 140. However, in an alternate embodiment, the main section could be movably mounted to the housing 70 in any suitable manner. The main section 130 is located at the top front side of the housing 70 and comprises a finger contact extension 142. The finger contact extension 142 extends in a rearward direction. The extension 142 extends past a vertical plane through a horizontal centerline 144 of the housing 70. The vertical plane, in the embodiment shown, is located at about the same location as the seam 144a between the front and rear housing members. However, in alternate embodiments the finger contact extension or the main section could have any suitable type of shape. As seen best in FIG. 4, the top of the main section 130 is located above the plunger 128 of the switch 126. The main section 130 is adapted to push the plunger 128 downward when the main section 130 is pivoted downward towards the top of the housing 70. However, any suitable type of system for actuating the switch 126 could be provided.

The cutting blade 132 is stationarily attached to the main section 130. The cutting blade 132 extends from the bottom of the main section 130. The spring 136 also extends from the bottom of the main section 130. The arm 134 extends forward from the main section 130. In a preferred embodiment the arm 134 is pivotably attached to the main section 130. The lid retainer assembly 138 is connected to the distal end of the arm 134.

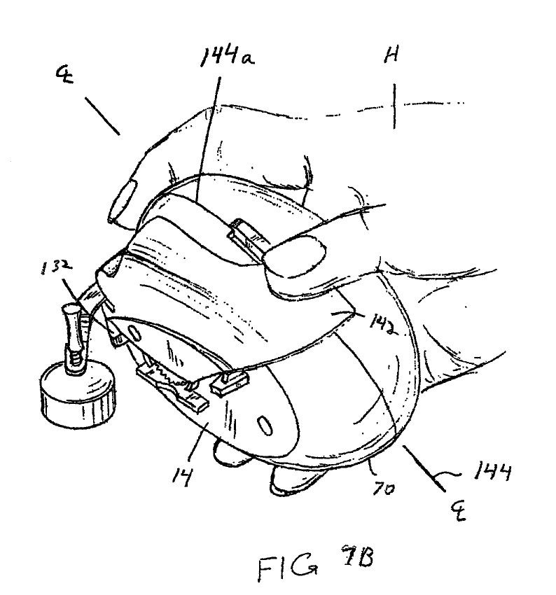

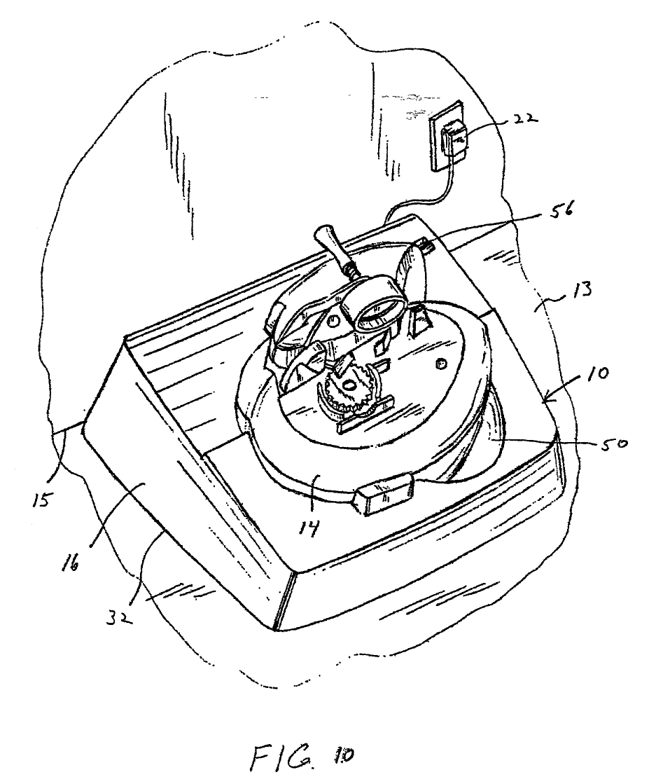

The lid retainer assembly 138 generally comprises a lid contacting extension 146, a magnet and plunger assembly 148, and a spring 150. Referring also to FIGS. 8 and 9, the magnet and plunger assembly 148 generally comprises a magnet 152, a rod 154 and a finger contact section 156. The lid contacting extension 146 is fixedly and stationarily attached to the end of the arm 134. Thus, the lid contacting extension 146 is restrained from moving relative to the arm 134. The lid contacting extension 146 preferably has an upside-down cup shape. The lid contacting extension 146 thus forms a magnet holding area with a generally open bottom side. However, the lid contacting extension could have any suitable shape. The top of the lid contacting extension 146 has a hole. The rod 154 slidably extends through the hole in the top of the lid contacting extension. The distal end of the arm 134 also comprises a hole which the rod 154 slidably extends through.

The magnet 152 is fixedly attached to the bottom end of the rod 154. The magnet 152 is movably located in the magnet receiving area of the lid contacting extension 146 between an up position as shown in FIG. 8 and a down position as shown in FIG. 9. The finger contact section 156 is fixedly attached to the top of the rod 154. In this embodiment the finger contact section 156 has a general contoured shape with concave lateral sides. However, the finger contact section could have any suitable type of shape and, could be integrally formed with the rod 154. The spring 150, in this embodiment, is a coil spring. The spring 150 is located between the top of the arm 134 and the bottom of the finger contact section 156. The spring 150 biases the magnet and plunger assembly 148 in the upward position as shown in FIG. 8.

Referring particularly to FIG. 9, when a lid L of a can and the lid retainer assembly 138 are placed against each other, the bottom surface 158 of the lid contacting extension 146 contacts the top of the lid L. The magnet 152, while in its up position as shown in FIG. 8, is close enough to the bottom surface 158 such that the magnet 152 is moved downward by magnetic forces, as shown by arrow A in FIG. 9, and against the lid L. The spring 150 is compressed. After the lid L is cut off of the can, the magnet and plunger assembly 148, lid contacting extension 146, and the cut lid L remain as shown in FIG. 9. After the can is removed from the can opener 14, the user can grasp the finger contact section 156 and pull upward as indicated by arrow B. The magnet and plunger assembly 148 can return to the up position as shown in FIG. 8. However, the lid contacting extension 146 prevents the lid L from moving upward with the magnet and plunger assembly 148. As the magnet 152 moves away from the cut lid L, the weight of the lid L and the reduced magnetic attraction force allow the lid L to fall away from the lid retainer assembly 138.

With the present invention a user does not need to contact the cut lid L in order to remove the lid from the magnetic attraction of the magnet 152. Thus, there is less risk that the user could cut his or her hand on the cut edge of the cut lid L. With this feature, a relatively large magnet 152 can be provided when compared to prior art can opener magnets. This can provide the features of more securely holding the cut lid L, allowing the magnet to securely hold larger and heavier lids, but at the same time allow an easier removal of the lid from the magnet with reduced risk that the user could cut his or her hand on the cut edge of the lid. In addition, if the underside of the lid L has food remnants against it, the user does not need to physically contact the food remnants. Instead, the user could place a towel or napkin under the lid L and catch the lid in the towel or napkin as the user pulls upward in direction B on the magnet and plunger assembly. Therefore, the user's hand does not need to contact food remnants on the underside of the lid L.

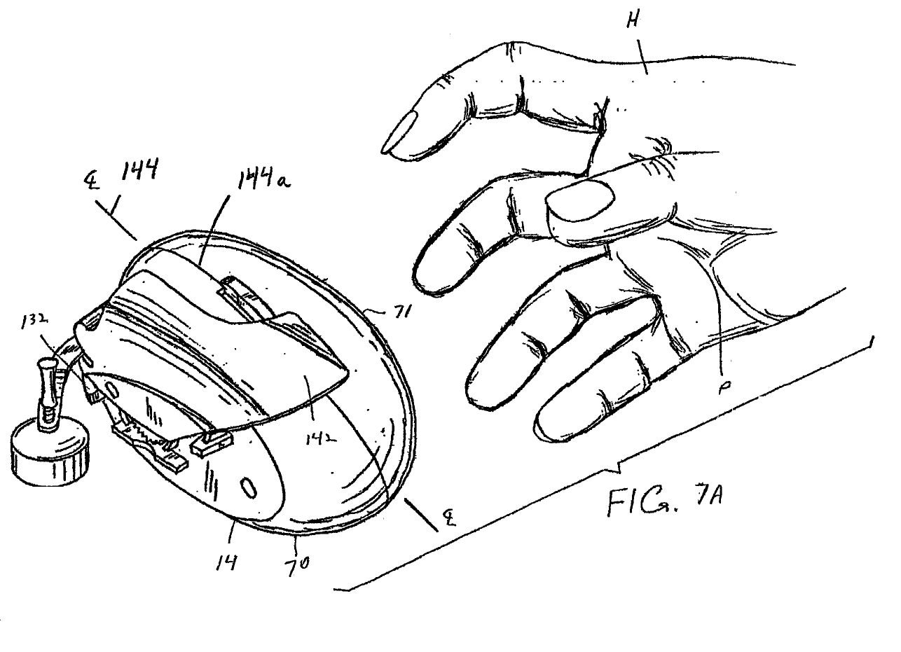

Referring now to FIGS. 7A and 7B, the can opener 14 is shown in relation to a hand H of a user. In this embodiment, the can opener 14 is suitably sized and shaped to be held in a right hand of the user. However, in an alternate embodiment, the can opener could be configured to be held in a left hand of a user or, alternatively, could be configured to be held in either a right hand or a left hand.

The general rounded shape of the housing 70 has been selected such that the can opener can be received in a single hand of the user and comfortably grasped by the user in a manner similar to the user grasping an egg or a ball. The rear end 71 of the housing is sized and shaped to be located against a palm P of the hand H along a majority of its length. One or two fingers could be located in the finger receiving recess 110. The thumb of the user's hand can be placed against the top side of the finger contacting extension 142. The remaining fingers of the user's hand can be placed against the bottom side of the housing 70.

With the user holding the can opener 14 in this grasping position, the user can articulate his or her thumb to depress the finger contacting extension 142. This, in turn, can depress the plunger 128 to actuate the switch 126 and cause the can contacting wheel 124 to rotate. In addition, the location of the user's thumb, relative to his or her other fingers allows the user to exert sufficient force between the housing 70 and the finger contacting section 142 to pierce the cutting blade 132 through the lid of a can. As noted above, the finger contacting extension 142 extends past the centerline 144 of the housing 70. This enables a user with a small hand to still be able to depress the finger contacting extension and have his or her fingers against the bottom of the housing 70. The general rounded or egg shape of the can opener allows the can opener to be provided without a handle section extending away from the main section 70 of the housing. This allows the can opener to be smaller than conventional powered can openers, allows the can opener mount to be smaller than conventional can opener mounts, and allows the can opener assembly to have a smaller footprint to take up less counter space or under cabinet space than conventional can openers.

FIGS. 7A and 7B illustrate use of the can opener 14 when the can opener has been removed from the mount 16. In this dismounted use configuration the battery 74 is used to power the motor 116. However, the can opener 14 does not need to be used only in its dismounted use configuration. Referring back to FIG. 1, the can opener 14 can also be used while attached to the mount 16. In this mounted use configuration the mount 16 supports the can opener 14 on the cabinet 12. The projection 109 is located in the recess 52 and the latch arm 60 is located in the recess 112. This stationarily latches the housing 70 to the mount 16. A can can be attached to the can opener 14, supported by the opener 14 and mount 16, and opened while the can opener 14 is attached to the mount 16. In this mounted use configuration the motor 116 is powered by electricity from the battery. When the can opener 14 is not being used, the electricity from the transformer 22 can be used to recharge the battery 74. Thus, with the present invention, the can opener assembly 10 provides both a mounted can opener use configuration as well as a dismounted can opener use configuration.

Referring now also to FIG. 10, the can opener assembly 10 is shown on a countertop surface 13. In this positioning, the mount 16 is not fixedly attached to the surface 13. The assembly 10 can be repositioned to any desired position on the countertop surface 13. The rear side 32 of the mount 16 is located directly against the surface 13. Because the end of the rear side 32 is along a flat plane, the rear side 32 stably locates the assembly 10 on the surface 13. In order to use the can opener 14, the can opener would be removed from the mount 16. The general wedge shaped side profile of the mount 16 presents the user with a more efficient access to the finger recess 50 and the lever 56 when the assembly 10 is located at the rear end 15 of the surface 13. The mount 16 allows positioning of the assembly 10 either on a relatively flat countertop surface or mounted to an underside of a cabinet. In addition, if mounted to an underside of a cabinet, the assembly 10 allows the can opener 14 to be used either while attached to the mount 16 or while disconnected from the mount as a moveable hand-held working unit.

In an alternate embodiment, the mount 16 could be adapted to be attached to a vertical wall. Features of the present invention could also be incorporated into other types of kitchen appliances or household appliances. Features of the present invention could be used with any suitable type of household appliance working unit, such as a blender, a knife sharpener, a flashlight, an electric carving knife, etc.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

What is claimed is:

1. A hand held battery operated can opener comprising;
a housing;
a drive located in the housing and having a can contact drive wheel;
a battery connected to the drive; and
a movable section movably connected to the housing, the movable section comprising a cutting blade,
wherein the housing is sized and shaped to be grasped by a single hand of a user in a grasping position, a back of the housing being sized and shaped to be generally matingly received on a user's palm, the grasping position comprising the back of the housing facing towards the palm of the hand and fingers of the hand being located at left and bottom sides of the housing and, the movable section is sized and shaped such that, while the user is grasping the housing in the grasping position, at least one finger of the hand can articulate to move the movable section.

2. A hand held battery operated can opener as in claim 1 wherein the housing has a general egg shaped profile.

3. A hand held battery operated can opener as in claim 1 wherein the housing comprises two general clam shell shaped members connected to each other.

4. A hand held battery operated can opener as in claim 1 wherein the movable section comprises a finger contact section which extends across a vertical plane through a horizontal centerline between a front end and a rear end of the housing.

5. A hand held battery operated can opener as in claim 1 wherein a left side of the housing is larger in height than a right side of the housing.

6. A hand held battery operated can opener as in claim 1 wherein a portion of the movable section extends across a majority of the length of a top side of the housing.

7. A hand held battery operated can opener as in claim 1 wherein the housing has a main section with a general rounded shape without a handle section extending from the main section.

8. A hand held battery operated can opener as in claim 1 wherein the drive comprises at least three gears operably connected to each other in series, at least two of the gears having main large gear sections substantially aligned in a same plane.

9. A hand held battery operated can opener as in claim 1 wherein the housing comprises a latching projection and a latching recess located on respective opposite sides of the housing.

10. A hand held battery operated can opener as in claim 1 further comprising electrical contacts connected to the battery, wherein the contacts are located along an exterior side of the housing.

11. A hand held battery operated can opener comprising:
a housing;
a drive located in the housing and having a can contacting drive wheel;
a battery connected to the drive; and
a movable section movably connected to the housing, the movable section comprising a cutting blade,
wherein the housing has a main section with a general rounded shape without a handle section extending from the main section, and wherein the main section is sized and shaped to be generally matingly held in a palm of a single hand of a user along a majority of its length.

12. A hand held battery operated can opener as in claim 11 wherein the housing has a general egg shaped profile.

13. A hand held battery operated can opener as in claim 11 wherein the housing comprises two general clam shell shaped members connected to each other.

14. A hand held battery operated can opener as in claim 11 wherein the movable section comprises a finger contact section which extends across a vertical plane through a horizontal centerline between a front end and a rear end of the housing.

15. A hand held battery operated can opener as in claim 11 wherein a left side of the housing is larger in height than a right side of the housing.

16. A hand held battery operated can opener as in claim 11 wherein a portion of the movable section extends across a majority of a length of a top side of the housing.

17. A hand held battery operated can opener as in claim 11 wherein the drive comprises at least three gears operably connected to each other in series, at least two of the gears having main large gear sections substantially aligned in a same plane.

18. A hand held battery operated can opener as in claim 11 wherein the housing comprises a latching projection and a latching recess located on respective opposite sides of the housing.

19. A hand held battery operated can opener as in claim 11 further comprising electrical contacts connected to the battery and located along an exterior of the housing.

20. A can opener assembly comprising:
a hand held can opener comprising a battery; and
a can opener mounting receptacle comprising a housing having a receiving area for removably receiving the can opener, electrical contacts at the receiving area, and an AC/DC transformer connected to the contacts,
wherein the can opener is adapted to operate when it is out of the receiving area by use of the battery and, when the can opener is in the receiving area, the can opener is adapted to operate by use of the battery and can receive electricity from the contacts for recharging the battery, and wherein the housing of the can opener mounting receptacle is adapted to be mounted to an underside of a cabinet.

21. A can opener assembly as in claim 20 further comprising a latching system for removably latching the can opener to the mounting receptacle.

22. A can opener assembly as in claim 21 wherein the latching system comprises a first side of the can opener having a recess, a bottom side of the can opener and a bottom of the receiving area having a mating projection and recess, and the mounting receptacle having a movable latch which is movable into and out of the recess in the first side of the can opener.

23. A can opener assembly as in claim 20 wherein the receiving area is located in a front side of the mounting receptacle.

24. A can opener assembly as in claim 20 wherein the receiving area has a general concave egg shaped profile.

25. A can opener assembly as in claim 20 wherein the housing of the can opener mounting receptacle has a side opposite a front side of the mounting receptacle which is sized and shaped to be placed on a flat countertop surface, wherein the can opener mounting receptacle is adapted to the mounted to an underside of a cabinet or placed on the flat countertop surface.

26. A can opener assembly comprising:
a hand-held can opener comprising a battery; and
a can opener mount having a housing, the housing having a front side with a can opener receiving area for removably mounting the can opener to the can opener mount, and a top side adapted to be attached to an underside of a cabinet.

27. A can opener assembly as in claim 26 wherein the housing of the can opener mount comprises a rear side which is sized and shaped to be placed on a flat surface and stabilize the housing from moving on the flat surface.

28. A can opener assembly as in claim 26 wherein the housing of the can opener mount comprises a bottom side which has a smaller dimension than the top side of the housing.

29. A can opener assembly as in claim 28 wherein the housing of the can opener mount has a general wedge shaped side profile.

30. A can opener assembly as in claim 26 wherein the receiving area has a general concave egg shaped profile.

31. A can opener assembly comprising:
a hand held can opener;
a can opener mount having a housing with a can opener receiving area; and
a latching system for removably connecting the can opener to the mount in the receiving area, the latching system comprising the can opener having a first recess on a first side and a first projection on a second side, the housing having a second recess at the receiving area, and a movable latch connected to the housing for engaging the first recess when the can opener is positioned in the receiving area.

32. A can opener assembly as in claim 31 wherein the second side of the can opener comprises a bottom side of the can opener.

33. A can opener assembly as in claim 32 wherein the first side of the can opener comprises a top side of the can opener.

34. A can opener assembly as in claim 31 wherein the second recess in the housing of the can opener mount is located along a bottom side of the receiving area.

35. A can opener assembly as in claim 31 wherein the moveable latch comprises a rotatable rod section, a latch arm extending from the rod section, and a user actuatable lever section extending from the rod section in a same direction as the latch arm.

36. A can opener assembly as in claim 35 wherein the latching system comprises a spring biasing the movable latch towards a latching position.

37. A can opener assembly as in claim 35 wherein the movable latch extends from a front side of the housing of the can opener mount.

38. A household appliance comprising:
a working unit comprising a rechargeable battery; and
a combined battery recharger and working unit mount having a housing with a working unit receiving area, electrical contacts connected to the housing, and a transformer connected to the contacts, the receiving area being adapted to receive the working unit therein,
wherein the housing comprises a first side with holes and a second side with a perimeter section forming an end of the second side along a plane, and
wherein the housing is adapted to be mounted to an underside of a cabinet with the first side facing the underside of the cabinet and the housing is adapted to be alternatively placed on a flat countertop surface with the end at the second side being located on the countertop surface to stabilizing the housing on the countertop surface.

39. A household appliance as in claim 38 wherein the housing comprises a general wedge shaped side profile.

40. A household appliance as in claim 38 wherein the receiving area is located into a third side of the housing, the third side being substantially perpendicular to the first side.

41. A household appliance as in claim 38 wherein the mount further comprises a movable latch for latching the working unit with the mount.

42. A household appliance as in claim 38 wherein the receiving area comprises a height dimension and a width dimension which are both larger than a depth dimension into the receiving area.

43. In a can opener having a housing, a drive located in the housing, a movable cutting blade connected to the housing and, a lid retainer connected to the housing, the improvement comprising:
the lid retainer including an arm connected to the housing with a lid contacting extension extending downward from an end of the arm, a magnet and plunger assembly movably connected to the end of the arm, and a spring biasing the magnet and plunger assembly in an upward direction, wherein the magnet and plunger assembly is movable relative to the lid contacting extension such that a user can pull upward on the magnet and plunger assembly to separate a magnet of the magnet and plunger assembly from a cut lid magnetically attached to the magnet.

44. A can opener as in claim 43 wherein the lid contacting extension comprises a general upside-down cup shape with a hole through a top of the lid contacting extension.

45. A can opener as in claim 44 wherein a rod section of the magnet and plunger assembly is slidably located in the hole.

46. A can opener as in claim 43 wherein the magnet and plunger assembly comprises a finger pulling section on a top of the rod section.

47. A can opener as in claim 43 wherein the lid contacting extension surrounds substantially all of the magnet except for a bottom surface of the magnet.

48. A can opener as in claim 43 wherein the magnet is movably located between an up position and a down position inside a movement area within the lid contacting extension.
